(19) United States
(12) Patent Application Publication
(10) Pub. No.: US 2024/0033800 A1
(43) Pub. Date: Feb. 1, 2024

(54) CAM-TYPE PRESS APPARATUS

(71) Applicants: Hyundai Motor Company, Seoul (KR); Kia Corporation, Seoul (KR); Hongik University Industry-Academia Cooperation Foundation, Seoul (KR)

(72) Inventors: Dae In LEE, Yeosu-Si (KR); Hyunjune YIM, Seoul (KR)

(73) Assignees: Hyundai Motor Company, Seoul (KR); Kia Corporation, Seoul (KR); Hongik University Industry-Academia Cooperation Foundation, Seoul (KR)

(21) Appl. No.: 17/989,410

(22) Filed: Nov. 17, 2022

(30) Foreign Application Priority Data
Jul. 27, 2022 (KR) 10-2022-0092987

(51) Int. Cl. B21D 19/08; B30B 1/26; B30B 15/02

(52) U.S. Cl. CPC B21D 19/084; B30B 1/261; B30B 1/266; B30B 15/02

(57) ABSTRACT

A cam-type press apparatus includes a lower die, an upper die corresponding to the lower die and provided to be vertically movable, a cam base configured on a first die among the lower die and the upper die, at least one cam block provided on the cam base, a slide base configured on a second die among the lower die and the upper die, a cam slide in cam-contact with the cam base and slidably provided on the slide base, and a plurality of wear plates provided in contact with each other between the cam base and the cam slide and between the slide base and the cam slide, where at least one first pair of wear plates among the plurality of wear plates is in point-contact or line-contact with each other.

### CROSS-REFERENCE TO RELATED APPLICATION

The present application claims priority to Korean Patent Application No. 10-2022-0092987 filed on Jul. 27, 2022, the entire contents of which is incorporated herein for all purposes by this reference.

### BACKGROUND OF THE PRESENT DISCLOSURE

### Field of the Present Disclosure

The present disclosure relates to a press apparatus. More particularly, the present disclosure relates to a cam-type press apparatus for press-forming a panel material into a preset shape in a sub-assembly line of a vehicle body.

### Description of Related Art

In general, to produce one finished body panel, it is necessary to go through several press-forming processes. Among these press forming processes, there is a process of forming a panel material into a preset shape using a cam-type press apparatus.

The cam-type press apparatus may be applied to a process for forming a flange on a panel material using an inclined cam structure. The cam-type press apparatus may form the panel material into a preset shape by the cam operation of a lower die and an upper die.

Furthermore, the cam-type press apparatus is provided with a plurality of wear plates provided between cam-actuating parts. Here, the plurality of wear plates are in surface-contact with each other, and In an exemplary embodiment of the present disclosure, may be provided in a flat plate type.

In such a cam-type press apparatus, because the cam-actuating parts are in cam-contact planarly by the plurality of wear plates, and the number of cam-contacting surfaces is excessive, an over-constraint is applied on the relative degrees of freedom of the cam-operating parts.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a cam-type press apparatus configured for applying a proper constraint rather than an over-constraint on the relative degree of freedom of cam-operating parts.

An exemplary cam-type press apparatus includes a lower die, an upper die corresponding to the lower die and provided to be vertically movable, a cam base configured on a first die among the lower die and the upper die, at least one cam block provided on the cam base, a slide base configured on a second die among the lower die and the upper die, a cam slide in cam-contact with the cam base and slidably provided on the slide base, and a plurality of wear plates provided in contact with each other between the cam base and the cam slide and between the slide base and the cam slide, where at least one first pair of wear plates among the plurality of wear plates is in point-contact or line-contact with each other.

Each of the wear plates may include at least one of a spherical surface, a circumferential surface, and a V-shaped groove surface.

Among the at least one first pair of wear plates, one may include a spherical surface, and another may include a flat surface in point-contact with the spherical surface.

Among the at least one first pair of wear plates, one may include a circumferential surface, and another may include a V-shaped groove surface or a flat surface in line-contact with the circumferential surface.

Each of at least one second pair of wear plates may include a flat surface to be in surface-contact with each other.

A spring may be provided on at least one of the at least one second pair of wear plates in surface-contact with each other through the flat surface.

An exemplary cam-type press apparatus includes a lower die, an upper die corresponding to the lower die and provided to be vertically movable, a cam base configured in a first die among the lower die and the upper die, at least one first cam block and at least one second cam block that are in cam-contact with each other and slidably provided on the cam base, a cam slide configured in a second die among the lower die and the upper die, disposed in cam-contact with the cam base, and slidably provided on a slide base, a plurality of cam drives configured in the second die among the lower die and the upper die, and configured to slide the at least one first cam block and the at least one second cam block, and a plurality of wear plates provided in contact with each other between the cam base and the cam slide, between the slide base and the cam slide, between the cam base and the plurality of cam drives, between the plurality of cam drives and the at least one first cam block, between the at least one first cam block and the at least one second cam block, and between the cam base and each of the at least one first cam block and the at least one second cam block, respectively, where at least one first pair of wear plates among the plurality of wear plates are in point-contact or line-contact with each other.

Each of the wear plates may include at least one of a spherical surface, a circumferential surface, and a V-shaped groove surface.

Among the at least one first pair of wear plates, one may include a spherical surface, and another may include a flat surface in point-contact with the spherical surface.

Among the at least one first pair of wear plates, one may include a circumferential surface, and another may include a V-shaped groove surface or a flat surface in line-contact with the circumferential surface.

Each of at least one second pair of wear plates may include a flat surface to be in surface-contact with each other.

A spring may be provided on at least one of the at least one second pair of wear plates in surface-contact with each other through the flat surface.

An exemplary cam-type press apparatus includes a lower die, an upper die corresponding to the lower die and provided to be vertically movable, a cam base configured in a first die among the lower die and the upper die, a rotary cam block rotatably provided on the cam base, a cam slide configured in a second die among the lower die and the upper die, disposed in cam-contact with the rotary cam block, and slidably provided on a slide base, and a plurality of wear plates provided in contact with each other between the rotary cam block and the cam slide and between the slide base and the cam slide, where at least one first pair of wear plates among the plurality of wear plates are in point-contact or line-contact with each other.

Each of the wear plates may include at least one of a spherical surface, a circumferential surface, and a V-shaped groove surface.

Among the at least one first pair of wear plates, one may include a spherical surface, and another may include a flat surface in point-contact with the spherical surface.

Among the at least one first pair of wear plates, one may include a circumferential surface, and another may include a V-shaped groove surface or a flat surface in line-contact with the circumferential surface.

Each of at least one second pair of wear plates may include a flat surface to be in surface-contact with each other.

A spring may be provided on at least one of the at least one second pair of wear plates in surface-contact with each other through the flat surface.

According to an exemplary embodiment of the present disclosure, by minimizing sliding wear of a plurality of wear plates in contact with each other and by alleviating constraints on operability to proper constraint, reproducibility in press-forming the panel material may be secured, and assembly quality of cam-operating parts may be secured.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A and FIG. 1B are front views schematically illustrating a cam-type press apparatus according to an exemplary embodiment of the present disclosure.

FIG. 2A and FIG. 2B are rear views schematically illustrating a cam-type press apparatus according to an exemplary embodiment of the present disclosure.

FIG. 3 is a lateral view schematically illustrating a cam-type press apparatus according to an exemplary embodiment of the present disclosure.

FIG. 4 is a partial perspective view schematically illustrating a cam-type press apparatus according to an exemplary embodiment of the present disclosure.

FIG. 5, FIG. 6 and FIG. 7 illustrate wear plate applied to a cam-type press apparatus according to an exemplary embodiment of the present disclosure.

FIG. 8A and FIG. 8B are front views schematically illustrating a cam-type press apparatus according to another exemplary embodiment of the present disclosure.

FIG. 9A and FIG. 9B are rear views schematically illustrating a cam-type press apparatus according to another exemplary embodiment of the present disclosure.

FIG. 10, FIG. 11, FIG. 12, FIG. 13, FIG. 14 and FIG. 15 are partial perspective views schematically illustrating a cam-type press apparatus according to another exemplary embodiment of the present disclosure.

FIG. 16A and FIG. 16B are front views schematically illustrating a cam-type press apparatus according to yet another exemplary embodiment of the present disclosure.

FIG. 17A and FIG. 17B are rear views schematically illustrating a cam-type press apparatus according to yet another exemplary embodiment of the present disclosure.

FIG. 18 is a lateral view schematically illustrating a cam-type press apparatus according to yet another exemplary embodiment of the present disclosure.

FIG. 19 is a partial perspective view schematically illustrating a cam-type press apparatus according to yet another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure will be described more fully hereinafter with reference to the accompanying drawings, in which exemplary embodiments of the present disclosure are shown. As those skilled in the art would realize, the described embodiments may be modified in various different ways, all without departing from the spirit or scope of the present disclosure.

The terminology used herein is for describing specific examples only and is not intended to be limiting of the present disclosure. As used herein, the singular forms are intended to include the plural forms as well, unless the context clearly indicates otherwise. As used herein, the term “comprises” and/or “comprising” refers to the presence of specified features, integers, steps, acts, elements and/or components, but it should also be understood that it does not exclude a presence or an addition of one or more other features, integers, steps, acts, components, and/or groups thereof. The term “coupled” denotes a physical relationship between two components in which components are directly connected to each other or indirectly through one or more intermediary components.

As used herein, the term “and/or” includes any one or all combinations of one or more related items. In addition, the term “operably connected” or the like means at least two members are directly or indirectly connected to each other. However, two members that are operably connected to each other do not always rotate with the same rotation speed and in the same rotation direction.

It is understood that the term “vehicle,” “vehicular,” “car,” or other similar term as used herein is inclusive of, in general, passenger vehicles including sports cars, sports utility vehicles (SUV), buses, trucks, various commercial vehicles, and inclusive of hybrid vehicles, electric vehicles, hybrid electric vehicles, hydrogen-powered vehicles, and other alternative fuel vehicles (e.g., fuels derived from resources other than petroleum).

Hereinafter, an example of the present disclosure is described in detail with reference to the accompanying drawing.

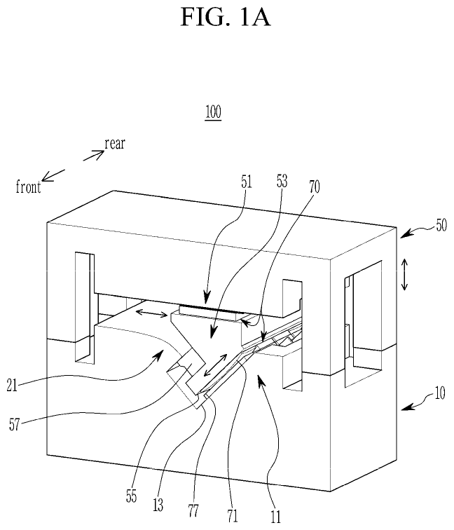

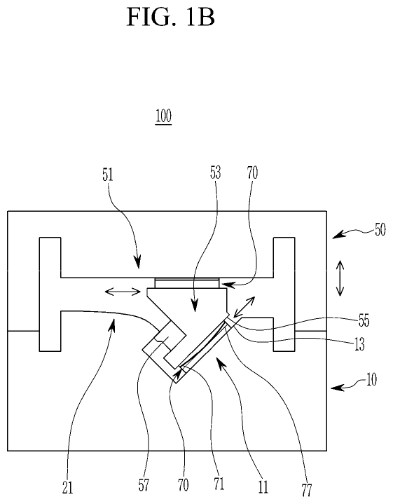

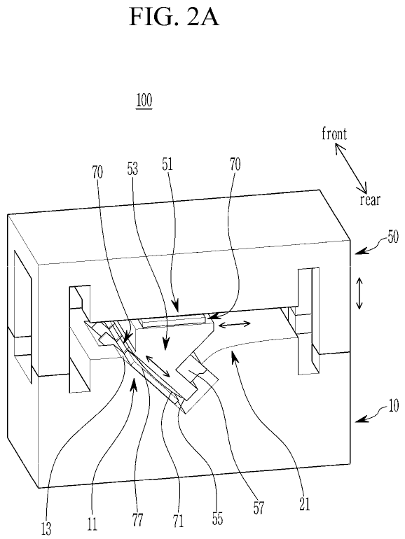

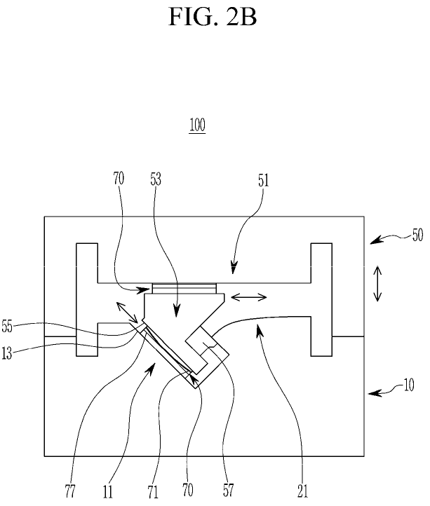

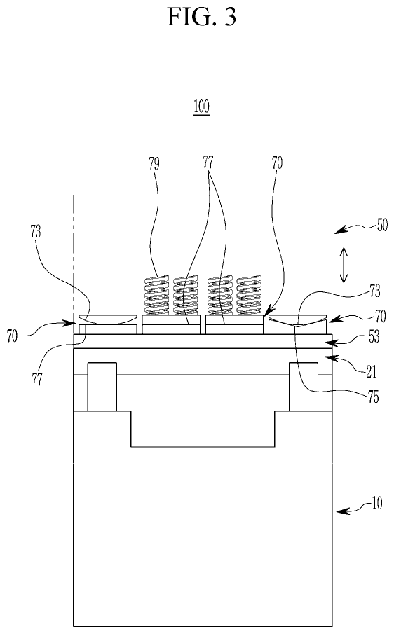

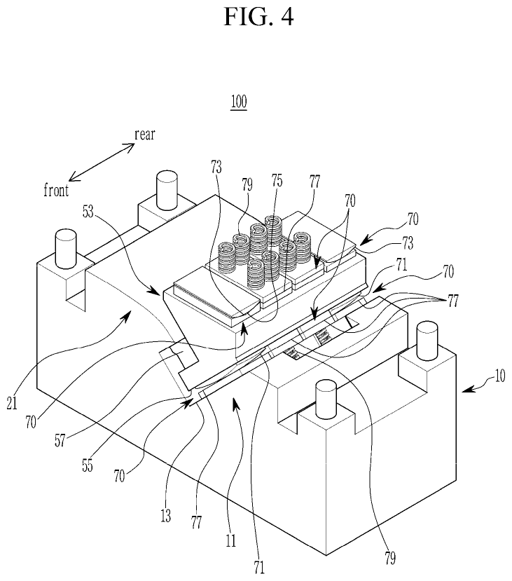

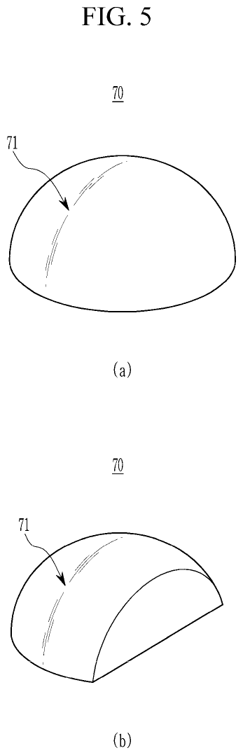

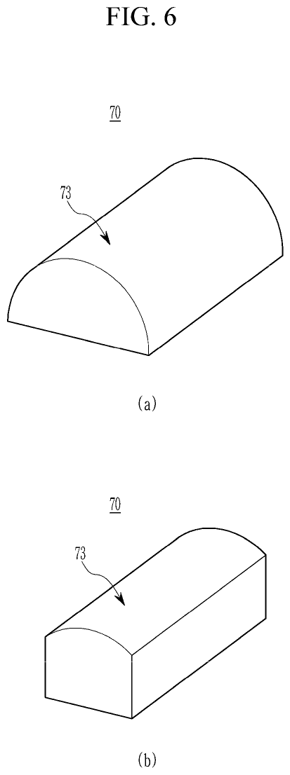

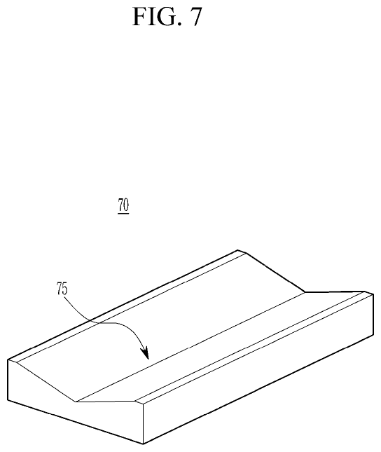

FIG. 1A and FIG. 1B are front views schematically illustrating a cam-type press apparatus according to an exemplary embodiment of the present disclosure. FIG. 2A and FIG. 2B are rear views schematically illustrating a cam-type press apparatus according to an exemplary embodiment of the present disclosure. FIG. 3 is a lateral view schematically illustrating a cam-type press apparatus according to an exemplary embodiment of the present disclosure. FIG. 4 is a partial perspective view schematically illustrating a cam-type press apparatus according to an exemplary embodiment of the present disclosure. FIG. 5, FIG. 6 and FIG. 7 illustrate a wear plate applied to a cam-type press apparatus according to an exemplary embodiment of the present disclosure.

Referring to FIG. 1A and FIG. 1B, FIG. 2A and FIG. 2B, FIG. 3, FIG. 3, FIG. 4, FIG. 5, FIG. 6, and FIG. 7, a cam-type press apparatus 100 according to various exemplary embodiments of the present disclosure may be applied to a process of forming a vehicle body panel assembled to a vehicle body to a preset shape.

Furthermore, the cam-type press apparatus 100 according to various exemplary embodiments of the present disclosure may be applied to various forming processes such as a draw forming process, a trim process, a piercing process, a flange process, a forming process, and a restrike process.

Furthermore, in the present specification, “upper end portion”, “upper portion”, “upper end”, or “upper portion surface” of a component indicates end portion, portion, end, or surface of the component that is relatively positioned higher in the drawing, and “lower end portion”, “lower portion”, “lower end”, or “lower portion surface” of a component indicates end portion, portion, end, or surface of the component that is relatively positioned lower in the drawing.

In addition, in the present specification, “end” (for example, one end, another end, or the like) of a component indicates an end of the component in any direction, and “end portion” (for example, one end portion, another end portion, or the like) of a component indicates a certain part of the component including the end.

The cam-type press apparatus 100 according to an exemplary embodiment of the present disclosure is configured to form a flange on a panel material using a cam structure.

In an exemplary embodiment of the present disclosure, the cam-type press apparatus 100 according to various exemplary embodiments of the present disclosure may include a press mold of a flying cam type.

The cam-type press apparatus 100 according to an exemplary embodiment of the present disclosure is configured so that reproducibility in press-forming the panel material may be secured by applying a proper constraint rather than an over-constraint on the relative degree of freedom of cam-operating parts.

Furthermore, an exemplary embodiment provides the cam-type press apparatus 100 configured for minimizing sliding wear between cam-operating parts and alleviating constraints on operability to proper constraint.

Here, the over-constraint may be defined as a constraint that cam-operating parts are in cam-contact planarly and the number of the cam-contacting surfaces is excessive. That is, the over-constraint may mean that the same degree of freedom of the component parts is multiply constrained. Such an over-constraint may deteriorate the ease of assembly of component parts, cause assembling deformation of component parts, and deteriorate reproducibility in press-forming the vehicle body panel.

Furthermore, the proper constraint may be defined as a constraint that a cam-contact with area between component parts is smaller than the over-constraint. That is, in an assembly structure of component parts on a proper constraint, the relative degree of freedom constraint between component parts may be always the same. Theory and application examples of the proper constraint may be found in related books and papers, for example, Alexander Slocum, “Kinematic couplings: A review of design principles and applications”, International Journal of Machine Tools & Manufacture, Vol. 50, 2010, pp. 310-327.

The cam-type press apparatus 100 according to an exemplary embodiment of the present disclosure includes a lower die 10, an upper die 50, and a plurality of wear plates 70.

In an exemplary embodiment of the present disclosure, the lower die 10 is fixed on a floor of a process work area. In an exemplary embodiment of the present disclosure, the lower die 10 includes a cam base 11 and at least one cam block 21.

The cam base 11 is provided as a base of the lower die 10. The cam base 11 includes a cam guider 13 which is vertically inclined.

The at least one cam block 21 may be fixed to the cam base 11 or integrally formed at the cam base 11. The at least one cam block 21 may be provided as a lower steel or forming pad which is configured to form a flange on a panel material.

In an exemplary embodiment of the present disclosure, the upper die 50 corresponds to the lower die 10, and is provided to be reciprocally movable in the vertical direction. The upper die 50 may reciprocally move along the vertical direction by a hydraulic cylinder device known to a person skilled in the art.

In an exemplary embodiment of the present disclosure, the upper die 50 includes a slide base 51 and a cam slide 53 slidably coupled to the slide base 51. The cam slide 53 is configured to cam-contact with the cam guider 13 of the lower die 10 along the vertical direction.

The cam slide 53 includes a cam surface 55 in cam-contact with the cam guider 13. The cam surface 55 is formed in a lower portion of the cam slide 53. The cam slide 53 is slidably provided on the slide base 51 along a horizontal direction thereof. Here, the cam slide 53 may return to an original position by a spring not shown in the drawings.

Furthermore, the cam slide 53 includes an upper steel 57 configured to form a flange on a panel material through the at least one cam block 21.

In an exemplary embodiment of the present disclosure, the plurality of wear plates 70 are provided in contact with each other between the cam slide 53 and a related part (e.g., the cam guider 13 and the slide base 51) of the cam slide 53 where sliding friction occurs.

The plurality of wear plates 70 slidably contact each other, and are configured to constrain translational degree of freedom of the cam slide 53.

Furthermore, the plurality of wear plates 70 may be differentiated from a plurality of wear plates according to the conventional art that are overall in surface-contact with each other and over-constrain translational degree of freedom of the cam slide 53.

The plurality of wear plates 70 according to an exemplary embodiment are configured to form different contact with areas and thereby to proper-constrain translational degree of freedom of the cam slide 53.

The plurality of wear plates 70 are provided in contact with each other between the cam guider 13 of the cam base 11 and the cam surface 55 of the cam slide 53, e.g., one wear plate on the cam guider 13 and another wear plate on the cam surface 55.

Furthermore, the plurality of wear plates 70 are provided in contact with each other between the slide base 51 and an upper portion of the cam slide 53, e.g., one wear plate on the slide base 51 and another wear plate on the upper portion of the cam slide 53

In an exemplary embodiment of the present disclosure, the plurality of wear plates 70 may be provided in point-contact, line-contact, or surface-contact with each other.

Furthermore, each of the wear plates 70 may include one of a spherical surface 71 (refer to FIG. 5), a circumferential surface 73 (refer to FIG. 6), a V-shaped groove surface 75 (refer to FIG. 7), and a flat surface 77.

In at least one first pair of wear plates 70 in contact with each other among the plurality of wear plates 70, one wear plate 70 includes the spherical surface 71, and another wear plate 70 includes the flat surface 77 in point-contact with the spherical surface 71.

In an exemplary embodiment of the present disclosure, the wear plates 70 provided on front and rear portions of the cam surface 55 of the cam slide 53 include the spherical surface 71, respectively. Furthermore, the wear plates 70 provided on front and rear portions of the cam guider 13 include the flat surface 77 in point-contact with the spherical surface 71, respectively.

Furthermore, in the at least one first pair of wear plates 70 in contact with each other among the plurality of wear plates 70, one includes the circumferential surface 73, and another includes the V-shaped groove surface 75 or the flat surface 77 which is in line-contact (e.g., single line-contact or dual line-contact) with the circumferential surface 73.

In an exemplary embodiment of the present disclosure, the wear plates 70 provided on front and rear portions of the slide base 51 include the circumferential surface 73, respectively. Furthermore, the wear plate 70 provided on a front portion of the upper portion of the cam slide 53 includes the V-shaped groove surface 75 in line-contact (e.g., dual line-contact) with the circumferential surface 73. Furthermore, the wear plate 70 provided on a rear portion of the upper portion of the cam slide 53 includes the flat surface 77 in line-contact (e.g., single line-contact) with the circumferential surface 73.

Furthermore, each of at least one second pair of wear plates 70 in contact with each other among the plurality of wear plates 70 includes the flat surface 77 in surface-contact with each other.

In an exemplary embodiment of the present disclosure, at least one wear plate 70 provided between the front and rear portions of the cam surface 55 of the cam slide 53 includes the flat surface 77. Furthermore, at least one wear plate 70 provided between the front and rear portions of the cam guider 13 includes the flat surface 77 in surface-contact with the flat surface 77.

Furthermore, at least one wear plate 70 provided between the front and rear portions of the slide base 51 includes the flat surface 77. Furthermore, at least one wear plate 70 provided between front and rear portions of the upper portion of the cam slide 53 includes the flat surface 77 in surface-contact with the flat surface 77.

Furthermore, a spring 79 may be provided on one of the at least second pair of wear plates 70 in surface-contact with each other through the flat surface 77.

Hereinafter, an operation of the cam-type press apparatus 100 according to an exemplary embodiment of the present disclosure is described in detail with reference to FIG. 1A and FIG. 1B, FIG. 2A and FIG. 2B, FIG. 3, FIG. 3, FIG. 4, FIG. 5, FIG. 6, and FIG. 7.

In an exemplary embodiment of the present disclosure, while a panel material is loaded on the at least one cam block 21 of the lower die 10, the upper die 50 moves downward.

Accordingly, the cam slide 53 of the upper die 50 slides downward through the cam surface 55 along the cam guider 13 of the lower die 10, and horizontally slides through the slide base 51.

Accordingly, the cam slide 53 may form a flange on the panel material supported by the at least one cam block 21, through the upper steel 57.

During the present process, the plurality of wear plates 70 slidably contact each other between the cam guider 13 of the cam base 11 and the cam surface 55 of the cam slide 53. Furthermore, the plurality of wear plates 70 slidably contact each other between the slide base 51 and the upper portion of the cam slide 53.

Here, the wear plates 70 respectively provided on the front and rear portions of the cam surface 55 of the cam slide 53 is in point-contact with the wear plates 70 respectively provided on front and rear portions of the flat surface 77 of the cam guider 13 through the spherical surface 71.

Furthermore, the wear plate 70 provided on a front portion of the slide base 51 is in line-contact with the V-shaped groove surface 75 of the wear plate 70 provided on the front portion of the upper portion of the cam slide 53 through the circumferential surface 73.

Furthermore, the wear plate 70 provided on a rear portion of the slide base 51 is in line-contact with the flat surface 77 of the wear plate 70 provided on the rear portion of the upper portion of the cam slide 53 through the circumferential surface 73.

Furthermore, at least one wear plate 70 provided between the front and rear portions of the cam surface 55 of the cam slide 53 is in surface-contact with at least one wear plate 70 provided between the front and rear portions of the cam guider 13 through the flat surface 77.

Furthermore, at least one wear plate 70 provided between the front and rear portions of the slide base 51 is in surface-contact with at least one wear plate 70 provided between the front and rear portions of the upper portion of the cam slide 53 through the flat surface 77.

In the instant case, as described above, one of the at least one second pair of wear plates 70 in surface-contact with each other through the flat surface 77 forms tightly contact with each other by an elastic force of the spring 79. That is, the spring 79 may elastically absorb dimensional deviations between the cam slide 53 and the cam guider 13, and between the slide base 51 and the cam slide 53.

According to the cam-type press apparatus 100 according to an exemplary embodiment of the present disclosure, each of the wear plates 70 slidably contacting each other during the cam operation of the cam slide 53 includes one of the spherical surface 71, the circumferential surface 73, the V-shaped groove surface 75, and the flat surface 77.

According to the cam-type press apparatus 100 according to an exemplary embodiment of the present disclosure, an appropriate degree of constraints of the cam-operating parts may be selected depending on the contact form of the plurality of wear plates 70.

In more detail, the degree of constraints of the plurality of wear plates 70 may be larger in the order of the surface-contact between the flat surface 77 and the flat surface 77, the line-contact (e.g., dual line-contact) between the circumferential surface 73 and the V-shaped groove surface 75, the line-contact (e.g., single line-contact) between the circumferential surface 73 and the flat surface 77, and the point-contact between the spherical surface 71 and the flat surface 77. The degree of constraints of the plurality of wear plates 70 may be selectively applied depending on designs of the cam-operating parts.

Therefore, according to the cam-type press apparatus 100 according to an exemplary embodiment of the present disclosure, by forming different contact with areas between the plurality of wear plates 70, a proper-constraint may be applied on the translational degree of freedom of the cam slide 53.

Furthermore, the plurality of wear plates 70 have split contact with areas, and may apply a proper-constraint on the relative degree of freedom of component portions due to small contact with area. Here, a pair in contact with each other among the plurality of wear plates 70 may apply the constraint on designated degree of freedom due to point-contact or line-contact between them, without applying a constraint on another degree of freedom.

Accordingly, according to the cam-type press apparatus 100 according to an exemplary embodiment of the present disclosure, a proper constraint rather than an over-constraint may be applied on the relative degree of freedom of cam-operating parts.

Accordingly, according to the cam-type press apparatus 100 according to an exemplary embodiment of the present disclosure, sliding wear of the plurality of wear plates 70 in contact with each other may be minimized and reproducibility in press-forming the vehicle body panel may be secured by alleviating constraints on operability to proper constraint. By securing the reproducibility, the deviation of the processing quality of the vehicle body panel may be decreased.

Furthermore, according to the cam-type press apparatus 100 according to an exemplary embodiment of the present disclosure, by optimizing the tolerance of the cam-operating parts, assembly quality of component parts may be secured, and assembling deformation of component parts may be prevented.

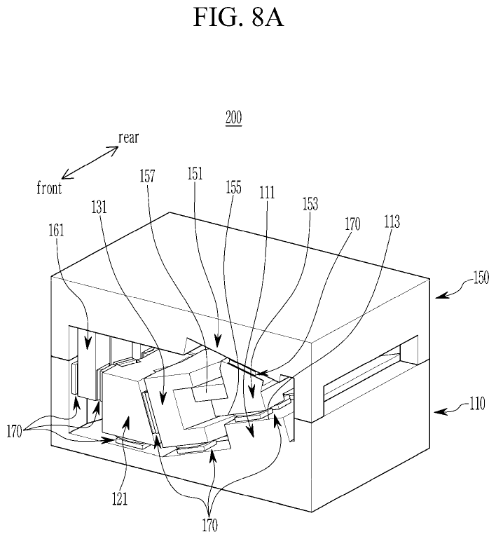

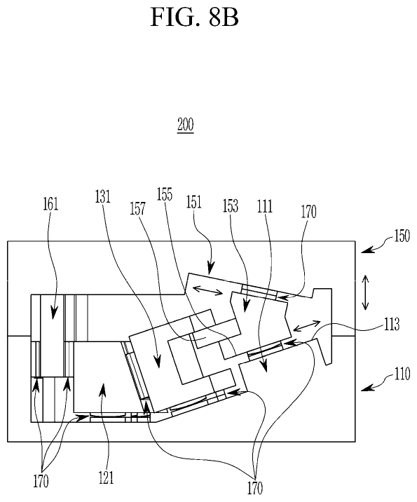

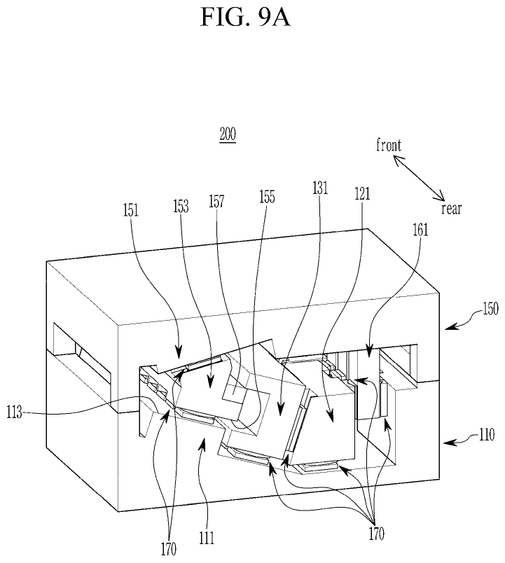

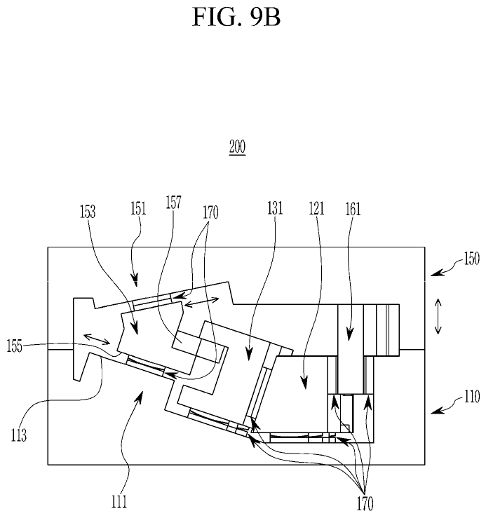

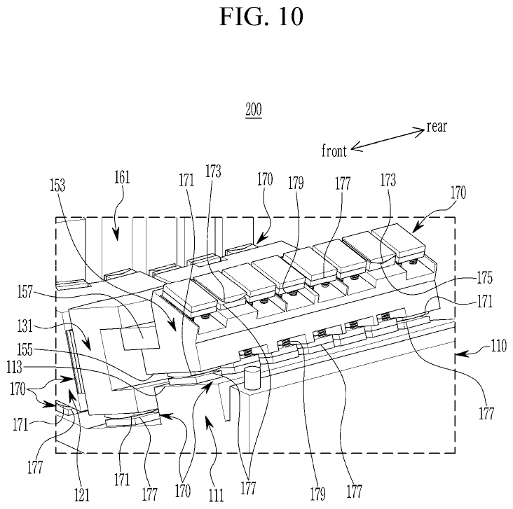

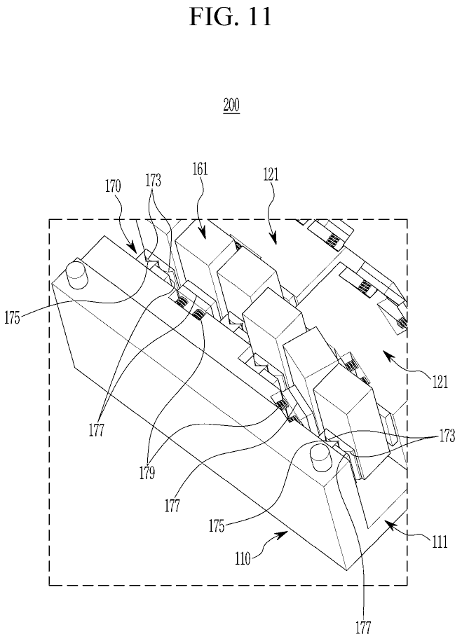

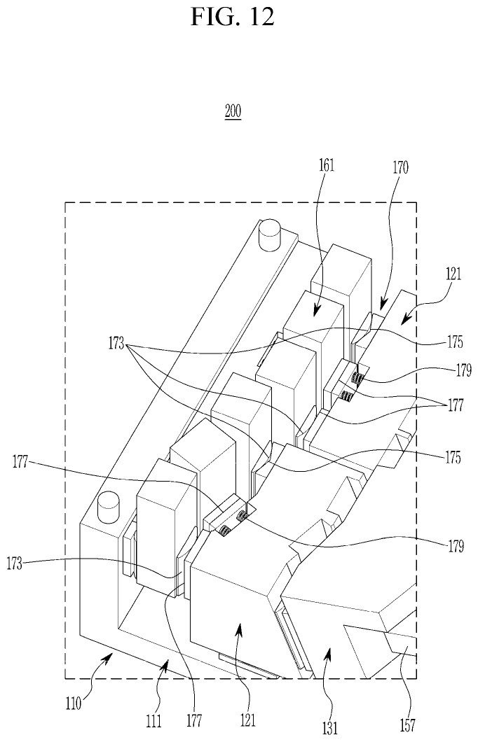

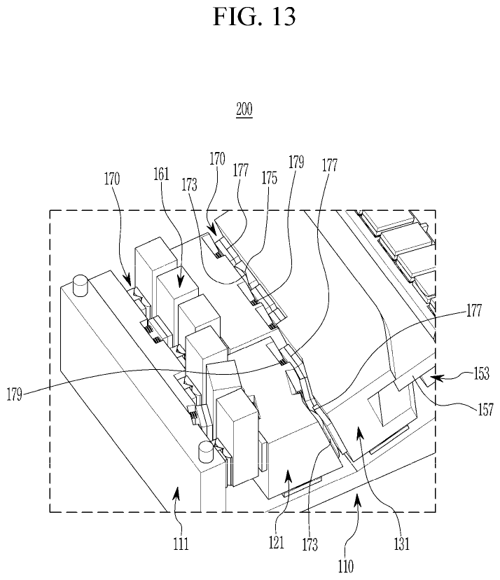

FIG. 8A and FIG. 8B are front views schematically illustrating a cam-type press apparatus according to another exemplary embodiment of the present disclosure. FIG. 9A and FIG. 9B are rear views schematically illustrating a cam-type press apparatus according to another exemplary embodiment of the present disclosure. FIG. 10, FIG. 11, FIG. 12, FIG. 13, FIG. 14 and FIG. 15 are partial perspective views schematically illustrating a cam-type press apparatus according to another exemplary embodiment of the present disclosure.

Referring to FIG. 8A and FIG. 8B, FIG. 9A and FIG. 9B, and FIG. 10, FIG. 11, FIG. 12, FIG. 13, FIG. 14 and FIG. 15, a cam-type press apparatus 200 according to another exemplary embodiment of the present disclosure may include a press mold of a double cam type.

The cam-type press apparatus 200 according to another exemplary embodiment includes a lower die 110, an upper die 150, and a plurality of wear plates 170.

In an exemplary embodiment of the present disclosure, the lower die 110 is fixed on a floor of the process work area. In an exemplary embodiment of the present disclosure, the lower die 110 includes the cam base 111, at least one first cam block 121, and at least one second cam block 131.

The cam base 111 is provided as a base of the lower die 110. The cam base 111 includes a cam guider 113 which is vertically inclined.

The at least one first cam block 121 and the at least one second cam block 131 are slidably provided on the cam base 111. One of the at least one first cam block 121 and the at least one second cam block 131, for example, the at least one second cam block 131, may be provided as a lower steel or forming pad which is configured to form a flange on a panel material.

In an exemplary embodiment of the present disclosure, the upper die 150 corresponds to the lower die 110, and is provided to be reciprocally movable in the vertical direction. The upper die 150 may reciprocally move along the vertical direction by a hydraulic cylinder device known to a person skilled in the art.

In an exemplary embodiment of the present disclosure, the upper die 150 includes a cam slide 153 and a plurality of cam drives 161.

The cam slide 153 is slidably provided on a slide base 151. The cam slide 153 is configured to cam-contact with the cam guider 113 of the lower die 110 along the vertical direction.

The cam slide 153 includes a cam surface 155 in cam-contact with the cam guider 113. The cam surface 155 is formed in a lower portion of the cam slide 153. The cam slide 153 is slidably coupled to the slide base 151 along the horizontal direction or a vertical inclined direction. Here, the cam slide 153 may return to an original position thereof by a spring not shown in the drawings.

Furthermore, the cam slide 153 includes an upper steel 157 configured to form a flange on a panel material through the at least one second cam block 131.

The plurality of cam drives 161 are configured to slide the at least one first cam block 121 and the at least one second cam block 131. The plurality of cam drives 161 are fixed to a lower portion of the upper die 150, and disposed with a preset interval along back and forth direction of the upper die 150.

In an exemplary embodiment of the present disclosure, the plurality of wear plates 170 are provided in contact with each other between the cam slide 153 and the plurality of cam drives 161 and related parts of the cam slide 153 and the plurality of cam drives 161, where sliding friction occurs, which is described in further detail below.

The plurality of wear plates 170 slidably contact each other, and are configured to constrain translational degree of freedom of the cam slide 153, the at least one first cam block 121, and the at least one second cam block 131.

Furthermore, the plurality of wear plates 170 may be differentiated from a plurality of wear plates according to the conventional art that are overall in surface-contact with each other and over-constrain translational degree of freedom of the cam slide 153, the at least one first cam block 121, and the at least one second cam block 131.

The plurality of wear plates 170 according to an exemplary embodiment are configured to form different contact with areas and thereby to proper-constrain translational degree of freedom of the cam slide 153, the at least one first cam block 121, and the at least one second cam block 131.

The plurality of wear plates 170 are provided in contact with each other between the cam guider 113 of the cam base 111 and the cam surface 155 of the cam slide 153, e.g., one wear plate on the cam guider 113 and another wear plate on the cam surface 155

The plurality of wear plates 170 are provided in contact with each other between the slide base 151 and an upper portion of the cam slide 153, e.g., one wear plate on the slide base 151 and another wear plate on the upper portion of the cam slide 153

The plurality of wear plates 170 are provided in contact with each other between the cam base 111 and the plurality of cam drives 161, e.g., one wear plate on the cam base 111 and another wear plate on the cam drive 161. The plurality of wear plates 170 are provided in contact with each other between each of the cam drives 161 and the at least one first cam block 121, e.g., one wear plate on the cam drive 161 and another wear plate on the first cam block 121

The plurality of wear plates 170 are provided in contact with each other between the at least one first cam block 121 and the at least one second cam block 131, e.g., one wear plate on the first cam block 121 and another wear plate on the second cam block 131

Furthermore, the plurality of wear plates 170 are provided in contact with each other between the cam base 111 and each of the at least one first cam block 121 and the at least one second cam block 131, e.g., one wear plate on the cam base 111 and another wear plate on the first cam block 121 or the second cam block 131.

In an exemplary embodiment of the present disclosure, the plurality of wear plates 170 may be provided in point-contact, line-contact, or surface-contact with each other. Furthermore, each of the wear plates 170 may include one of a spherical surface 171, a circumferential surface 173, a V-shaped groove surface 175, and a flat surface 177, the same as in the above-described exemplary embodiment of the present disclosure.

In an exemplary embodiment of the present disclosure, the wear plates 170 provided on front and rear portions of the cam surface 155 of the cam slide 153 include the spherical surface 171, respectively. Furthermore, the wear plates 170 provided on front and rear portions of the cam guider 113 include the flat surface 177 in point-contact with the spherical surface 171, respectively.

In another example, the wear plates 170 provided on front and rear portions of each of the at least one first cam block 121 and the at least one second cam block 131 include the spherical surface 171, respectively. Furthermore, the wear plates 170 provided on front and rear portions of the cam base 111 include the flat surface 177 in point-contact with the spherical surface 171, respectively.

Furthermore, in at least one first pair of wear plates 170 in contact with each other among the plurality of wear plates 170, one includes the circumferential surface 173, and another includes the V-shaped groove surface 175 or the flat surface 177 which is in line-contact (e.g., single line-contact or dual line-contact) with the circumferential surface 173.

In an exemplary embodiment of the present disclosure, the wear plates 170 provided on front and rear portions of the slide base 151 include the circumferential surface 173, respectively. Furthermore, the wear plate 170 provided on a front portion of the upper portion of the cam slide 153 includes the flat surface 177 in line-contact (e.g., single line-contact) with the circumferential surface 173. Furthermore, the wear plate 170 provided on a rear portion of the upper portion of the cam slide 153 includes the V-shaped groove surface 175 in line-contact (e.g., dual line-contact) with the circumferential surface 173.

In another example, among the plurality of cam drives 161, the wear plates 170 provided on one side surface of each of the cam drives 161 disposed on front and rear sides and at least one cam drive 161 disposed between the front and rear sides include the circumferential surface 173. Furthermore, the wear plates 170 provided on front and rear portions of the cam base 111 and between the front and rear portions of the cam base 111 include the V-shaped groove surface 175 and the flat surface 177 in line-contact (e.g., single line-contact and dual line-contact) with the circumferential surface 173.

In yet another example, the wear plate 170 provided on another side surface of the cam drive 161 corresponding to front and rear portions of the at least one first cam block 121 includes the circumferential surface 173. Furthermore, the wear plate 170 provided on a front portion of the at least one first cam block 121 includes the flat surface 177 in line-contact (e.g., single line-contact) with the circumferential surface 173. Furthermore, the wear plate 170 provided on a rear portion of the at least one first cam block 121 includes the V-shaped groove surface 175 in line-contact (e.g., dual line-contact) with the circumferential surface 173.

Furthermore, between the at least one first cam block 121 and the at least one second cam block 131, at least one wear plate 170 provided in the at least one first cam block 121 includes the circumferential surface 173. Furthermore, the wear plate 170 provided in the at least one second cam block 131 includes the V-shaped groove surface 175 or the flat surface 177 in line-contact (e.g., single line-contact or dual line-contact) with the circumferential surface 173.

Furthermore, each of at least one second pair of wear plates 170 in contact with each other among the plurality of wear plates 170 includes the flat surface 177 in surface-contact with each other.

In an exemplary embodiment of the present disclosure, at least one wear plate 170 provided between the front and rear portions of the cam surface 155 of the cam slide 153 includes the flat surface 177. Furthermore, at least one wear plate 170 provided between the front and rear portions of the cam guider 113 includes the flat surface 177 in surface-contact with the flat surface 177.

Furthermore, at least one wear plate 170 provided between the front and rear portions of the slide base 151 includes the flat surface 177. Furthermore, at least one wear plate 170 provided between the front and rear portions of the upper portion of the cam slide 153 includes the flat surface 177 in surface-contact with the flat surface 177.

In another example, at least one wear plate 170 provided between the front and rear portions of each of the at least one first cam block 121 and the at least one second cam block 131 includes the flat surface 177. In correspondence with the at least one wear plate 170, at least one wear plate 170 provided in the cam base 111 includes the flat surface 177 in surface-contact with the flat surface 177.

Furthermore, among the plurality of cam drives 161, the wear plate 170 provided on the one side surface of the at least one cam drive 161 disposed between the front and read sides includes the flat surface 177. In correspondence with the wear plate 170, at least one wear plate 170 provided in the cam base 111 includes the flat surface 177 in surface-contact with the flat surface 177.

In yet another example, at least one wear plate 170 provided between the front and rear portions of the at least one first cam block 121 includes the flat surface 177. In correspondence with the at least one wear plate 170, the wear plate 170 provided on another side surface of at least one cam drive 161 includes the flat surface 177 in surface-contact with the flat surface 177.

Furthermore, between the at least one first cam block 121 and the at least one second cam block 131, at least one wear plate 170 provided in the at least one first cam block 121 includes the flat surface 177. In correspondence with the at least one wear plate 170, at least one wear plate 170 provided in the at least one second cam block 131 includes the flat surface 177 in surface-contact with the flat surface 177.

Furthermore, a spring 179 may be provided on one of the at least one second pair of wear plates 170 in surface-contact with each other through the flat surface 177.

Hereinafter, an operation of the cam-type press apparatus 200 according to another exemplary embodiment of the present disclosure is described in detail with reference to FIG. 8A and FIG. 8B, FIG. 9A and FIG. 9B, and FIG. 10, FIG. 11, FIG. 12, FIG. 13, FIG. 14 and FIG. 15.

In an exemplary embodiment of the present disclosure, while a panel material is loaded on the at least one second cam block 131 of the lower die 110, the upper die 150 moves downward.

Here, the plurality of cam drives 161 of the upper die 150 are in cam-contact with and slide along the cam base 111 of the lower die 110 and the at least one first cam block 121, and move the at least one first cam block 121 and the at least one second cam block 131 to slide.

Simultaneously, the cam slide 153 of the upper die 150 slides downward through the cam surface 155 along the cam guider 113 of the lower die 110, and horizontally slides through the slide base 151.

Accordingly, the cam slide 153 may form a flange on the panel material supported by the at least one second cam block 131, through the upper steel 157.

During the present process, the plurality of wear plates 170 slidably contact each other between the cam base 111 and the plurality of cam drives 161, and between the plurality of cam drives 161 and the at least one first cam block 121.

Furthermore, the plurality of wear plates 170 slidably contact each other between the at least one first cam block 121 and the at least one second cam block 131, and between the cam base 111 and each of the at least one first cam block 121 and the at least one second cam block 131.

Furthermore, the plurality of wear plates 170 slidably contact each other between the cam guider 113 of the cam base 111 and the cam surface 155 of the cam slide 153. Furthermore, the plurality of wear plates 170 slidably contact each other between the slide base 151 and the upper portion of the cam slide 153.

Here, the at least one first pair of wear plates 170 in contact with each other may form point-contact to the flat surface 177 through the spherical surface 171, and may form line-contact between the V-shaped groove surface 175 and/or the flat surface 177 through the circumferential surface 173. Furthermore, the at least one second pair of wear plates 170 may be in surface-contact with each other through the flat surface 177.

Therefore, according to the cam-type press apparatus 200 according to another exemplary embodiment of the present disclosure, by forming different contact with areas between the plurality of wear plates 170, a proper-constraint may be applied on the translational degree of freedom of the cam slide 153, the at least one first cam block 121, the at least one second cam block 131, and the plurality of cam drives 161.

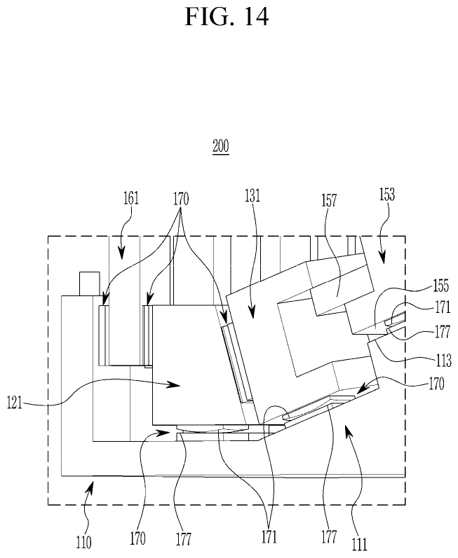

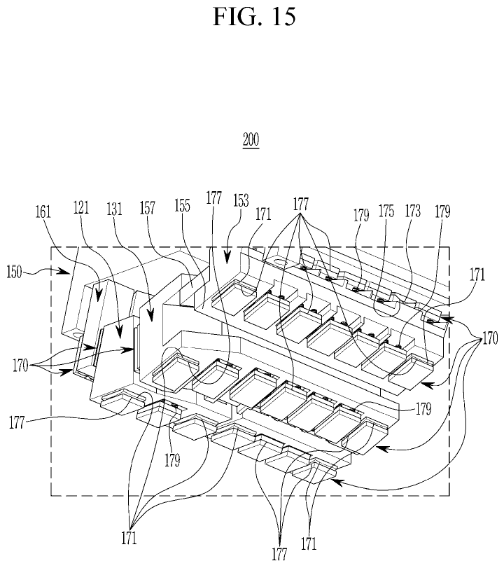

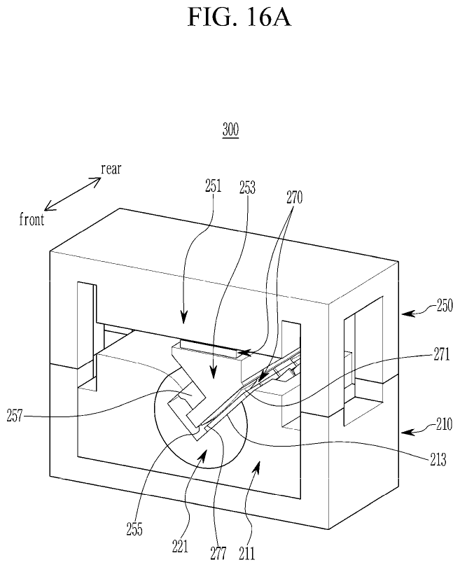

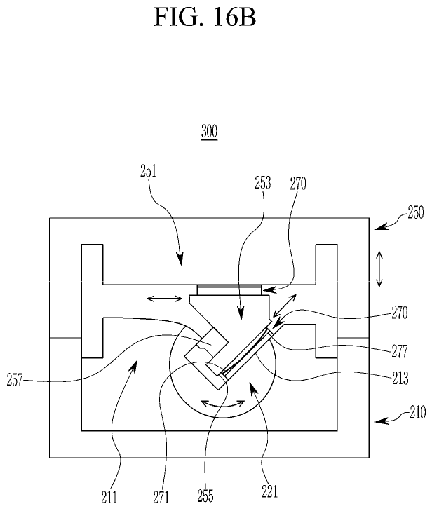

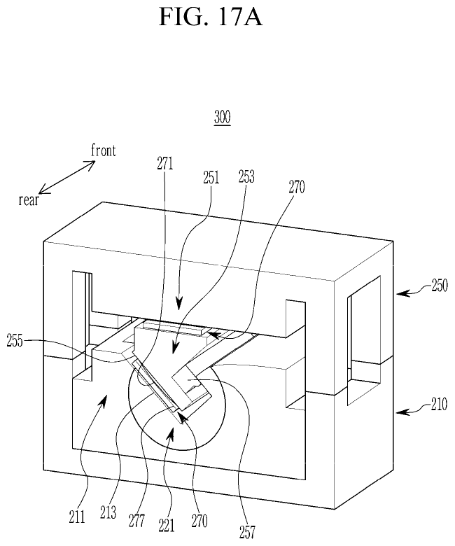

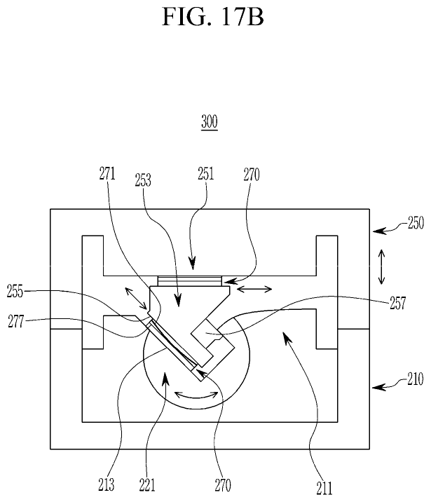

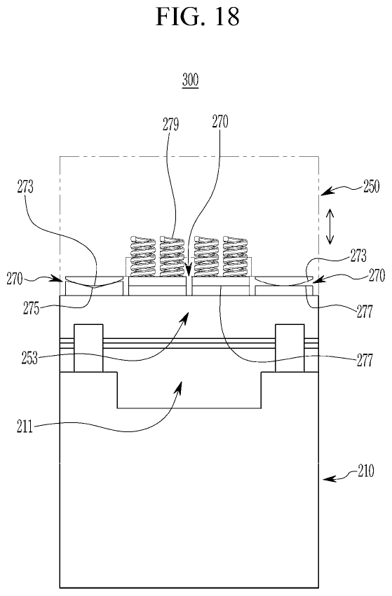

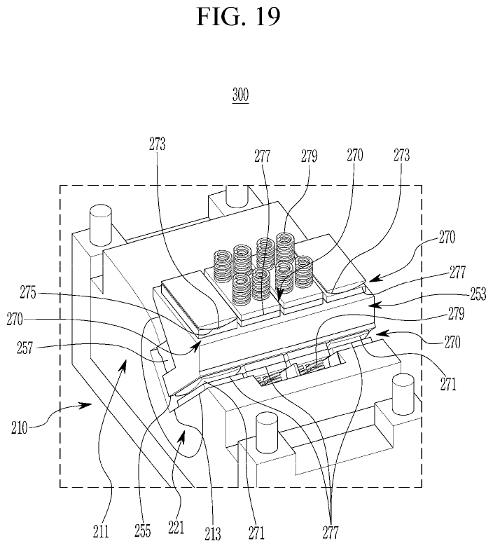

Other operations and effects of the cam-type press apparatus 200 according to another exemplary embodiment are the same as in the above-described exemplary embodiment of the present disclosure, and are not described in further detail. FIG. 16A and FIG. 16B are front views schematically illustrating a cam-type press apparatus according to yet another exemplary embodiment of the present disclosure. FIG. 17A and FIG. 17B are rear views schematically illustrating a cam-type press apparatus according to yet another exemplary embodiment of the present disclosure. FIG. 18 is a lateral view schematically illustrating a cam-type press apparatus according to yet another exemplary embodiment of the present disclosure. FIG. 19 is a partial perspective view schematically illustrating a cam-type press apparatus according to yet another exemplary embodiment of the present disclosure.

Referring to FIG. 16A and FIG. 16B, FIG. 17A and FIG. 17B, FIG. 18 and FIG. 19, a cam-type press apparatus 300 according to various exemplary embodiments of the present disclosure may include a press mold of a rotary cam type.

The cam-type press apparatus 300 according to various exemplary embodiments includes a lower die 210, an upper die 250, and a plurality of wear plates 270.

In an exemplary embodiment of the present disclosure, the lower die 210 is fixed on a floor of the process work area. In an exemplary embodiment of the present disclosure, the lower die 210 includes a cam base 211 and a rotary cam block 221.

The cam base 211 is provided as a base of the lower die 210. The rotary cam block 221 is disposed along back and forth direction of the lower die 210, and rotatably provided on the cam base 211.

The rotary cam block 221 may be provided as a lower steel or forming pad which is configured to form a flange on a panel material. The rotary cam block 221 includes a cam guider 213 which is vertically inclined. Furthermore, the rotary cam block 221 rotates by an external force (e.g., a driving torque), and may return to an original position thereof by a spring not shown in the drawings.

In an exemplary embodiment of the present disclosure, the upper die 250 corresponds to the lower die 210, and is provided to be reciprocally movable in the vertical direction. The upper die 250 may reciprocally move along the vertical direction by a hydraulic cylinder device known to a person skilled in the art.

In an exemplary embodiment of the present disclosure, the upper die 250 includes a slide base 251 and a cam slide 253 slidably coupled to the slide base 251. The cam slide 253 is configured to cam-contact with the cam guider 213 of the rotary cam block 221 along the vertical direction.

The cam slide 253 includes a cam surface 255 in cam-contact with the cam guider 213. The cam surface 255 is formed in a lower portion of the cam slide 253. The cam slide 253 is slidably provided on the slide base 251 along the horizontal direction thereof. Here, the cam slide 253 may return to an original position thereof by a spring not shown in the drawings.

Furthermore, the cam slide 253 includes an upper steel 257 configured to form a flange on a panel material through the rotary cam block 221.

In an exemplary embodiment of the present disclosure, the plurality of wear plates 270 are provided in contact with each other between the cam slide 253 and a related part (e.g., the cam guider 213 and the slide base 251) of the cam slide 253 where sliding friction occurs.

The plurality of wear plates 270 slidably contact each other, and are configured to constrain translational degree of freedom of the cam slide 253 and to constrain rotation degree of freedom of the rotary cam block 221.

Furthermore, the plurality of wear plates 270 may be differentiated from a plurality of wear plates according to the conventional art that are overall in surface-contact with each other and over-constrain translational degree of freedom of the cam slide 253 and rotation degree of freedom of the rotary cam block 221.

The plurality of wear plates 270 according to an exemplary embodiment are configured to form different contact with areas and thereby to proper-constrain translational degree of freedom of the cam slide 253 and rotation degree of freedom of the rotary cam block 221.

The plurality of wear plates 270 are provided in contact with each other between the cam guider 213 of the rotary cam block 221 and the cam surface 255 of the cam slide 253, e.g., one wear plate on the cam guider 213 and another wear plate on the cam surface 255

Furthermore, the plurality of wear plates 270 are provided in contact with each other between the slide base 251 and an upper portion of the cam slide 253, e.g., one wear plate on the slide base 251 and another wear plate on the upper portion of the cam slide 253.

In an exemplary embodiment of the present disclosure, the plurality of wear plates 270 may be provided in point-contact, line-contact, or surface-contact with each other. Furthermore, each of the wear plates 270 may include one of a spherical surface 271, a circumferential surface 273, a V-shaped groove surface 275, and a flat surface 277, the same as in the above-described exemplary embodiments of the present disclosure.

In at least one first pair of wear plates 270 in contact with each other among the plurality of wear plates 270, one wear plate 270 includes the spherical surface 271, and another wear plate 270 includes the flat surface 277 in point-contact with the spherical surface 271.

In an exemplary embodiment of the present disclosure, the wear plates 270 provided on front and rear portions of the cam surface 255 of the cam slide 253 include the spherical surface 271, respectively. Furthermore, the wear plates 270 provided on front and rear portions of the cam guider 213 include the flat surface 277 in point-contact with the spherical surface 271, respectively.

Furthermore, in the at least one first pair of wear plates 270 in contact with each other among the plurality of wear plates 270, one includes the circumferential surface 273, and another includes the V-shaped groove surface 275 or the flat surface 277 which is in line-contact (e.g., single line-contact or dual line-contact) with the circumferential surface 273.

In an exemplary embodiment of the present disclosure, the wear plates 270 provided on front and rear portions of the slide base 251 include the circumferential surface 273, respectively. Furthermore, the wear plate 270 provided on a front portion of the upper portion of the cam slide 253 includes the V-shaped groove surface 275 in line-contact (e.g., dual line-contact) with the circumferential surface 273. Furthermore, the wear plate 270 provided on a rear portion of the upper portion of the cam slide 253 includes the flat surface 277 in line-contact (e.g., single line-contact) with the circumferential surface 273.

Furthermore, each of at least one second pair of wear plates 270 in contact with each other among the plurality of wear plates 270 includes the flat surface 277 in surface-contact with each other.

In an exemplary embodiment of the present disclosure, at least one wear plate 270 provided between the front and rear portions of the cam surface 255 of the cam slide 253 includes the flat surface 277. Furthermore, at least one wear plate 270 provided between the front and rear portions of the cam guider 213 includes the flat surface 277 in surface-contact with the flat surface 277.

Furthermore, at least one wear plate 270 provided between the front and rear portions of the slide base 251 includes the flat surface 277. Furthermore, at least one wear plate 270 provided between the front and rear portions of the upper portion of the cam slide 253 includes the flat surface 277 in surface-contact with the flat surface 277.

Furthermore, a spring 279 may be provided on one of the at least one second pair of wear plates 270 in surface-contact with each other through the flat surface 277.

Hereinafter, an operation of the cam-type press apparatus 300 according to various exemplary embodiments are described in detail with reference to FIG. 16A and FIG. 16B, FIG. 17A and FIG. 17B, FIG. 18 and FIG. 19.

In an exemplary embodiment of the present disclosure, while a panel material is loaded on the rotary cam block 221 of the lower die 210, the upper die 250 moves downward.

Accordingly, the cam slide 253 of the upper die 250 slides downward through the cam surface 255 along the cam guider 213 of the rotary cam block 221, and horizontally slides through the slide base 251.

Accordingly, the rotary cam block 221 rotates, and the cam slide 253 may form a flange on the panel material supported by the rotary cam block 221, through the upper steel 257.

During the present process, the plurality of wear plates 270 slidably contact each other between the cam guider 213 of the rotary cam block 221 and the cam surface 255 of the cam slide 253. Furthermore, the plurality of wear plates 270 slidably contact each other between the slide base 251 and the upper portion of the cam slide 253.

Here, the at least one first pair of wear plates 270 in contact with each other may form point-contact to the flat surface 277 through the spherical surface 271, and may form line-contact to the V-shaped groove surface 275 and/or the flat surface 277 through the circumferential surface 273. Furthermore, the at least one second pair of wear plates 270 may be in surface-contact with each other through the flat surface 277.

Therefore, according to the cam-type press apparatus 300 according to various exemplary embodiments of the present disclosure, by forming different contact with areas between the plurality of wear plates 270, a proper-constraint may be applied on the translational degree of freedom of the cam slide 253 and the rotation degree of freedom of the rotary cam block 221.

Other operations and effects of the cam-type press apparatus 300 according to various exemplary embodiments are the same as in the above-described exemplary embodiment of the present disclosure, and are not described in further detail.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A press apparatus comprising:
a lower die;
an upper die corresponding to the lower die and provided to be vertically movable;
a cam base configured on a first die among the lower die and the upper die;
at least one cam block provided on the cam base;
a slide base configured on a second die among the lower die and the upper die;
a cam slide in cam-contact with the cam base and slidably provided on the slide base; and
a plurality of wear plates provided in contact with each other between the cam base and the cam slide and between the slide base and the cam slide,
wherein at least one first pair of wear plates among the plurality of wear plates is in point-contact or line-contact with each other.

2. The press apparatus of claim 1, wherein each of the wear plates includes at least one of a spherical surface, a circumferential surface, and a V-shaped groove surface.

3. The press apparatus of claim 1, wherein, among the at least one first pair of wear plates, one includes a spherical surface, and another includes a flat surface in point-contact with the spherical surface.

4. The press apparatus of claim 1, wherein, among the at least one first pair of wear plates, one includes a circumferential surface, and another includes a V-shaped groove surface or a flat surface in line-contact with the circumferential surface.

5. The press apparatus of claim 1, wherein each of at least one second pair of wear plates among the plurality of wear plates includes a flat surface to be in surface-contact with each other.

6. The press apparatus of claim 5, wherein a spring is provided on at least one of the at least one second pair of wear plates in surface-contact with each other through the flat surface.

7. A cam-type press apparatus, comprising:
a lower die;
an upper die corresponding to the lower die and provided to be vertically movable;
a cam base configured in a first die among the lower die and the upper die;
at least one first cam block and at least one second cam block that are in cam-contact with each other and slidably provided on the cam base;
a cam slide configured in a second die among the lower die and the upper die, disposed in cam-contact with the cam base, and slidably provided on a slide base;
a plurality of cam drives configured in the second die among the lower die and the upper die, and configured to slide the at least one first cam block and the at least one second cam block; and
a plurality of wear plates provided in contact with each other between the cam base and the cam slide, between the slide base and the cam slide, between the cam base and the plurality of cam drives, between the plurality of cam drives and the at least one first cam block, between the at least one first cam block and the at least one second cam block, and between the cam base and each of the at least one first cam block and the at least one second cam block, respectively,
wherein at least one first pair of wear plates among the plurality of wear plates are in point-contact or line-contact with each other.

8. The press apparatus of claim 7, wherein each of the wear plates includes at least one of a spherical surface, a circumferential surface, and a V-shaped groove surface.

9. The press apparatus of claim 7, wherein, among the at least one first pair of wear plates, one includes a spherical surface, and another includes a flat surface in point-contact with the spherical surface.

10. The press apparatus of claim 7, wherein, among the at least one first pair of wear plates, one includes a circumferential surface, and another includes a V-shaped groove surface or a flat surface in line-contact with the circumferential surface.

11. The press apparatus of claim 7,
wherein each of at least one second pair of wear plates among the plurality of wear plates includes a flat surface to be in surface-contact with each other; and
wherein a spring is provided on at least one of the at least one second pair of wear plates in surface-contact with each other through the flat surface.

12. A press apparatus including a lower die and an upper die corresponding to the lower die and provided to be vertically movable, the press apparatus including:
a cam base configured in a first die among the lower die and the upper die;
a rotary cam block rotatably provided on the cam base;
a cam slide configured in a second die among the lower die and the upper die, disposed in cam-contact with the rotary cam block, and slidably provided on a slide base; and
a plurality of wear plates provided in contact with each other between the rotary cam block and the cam slide and between the slide base and the cam slide,
wherein at least one first pair of wear plates among the plurality of wear plates are in point-contact or line-contact with each other.

13. The press apparatus of claim 12, wherein each of the wear plates includes at least one of a spherical surface, a circumferential surface, and a V-shaped groove surface.

14. The press apparatus of claim 12, wherein, among the at least one first pair of wear plates, one includes a spherical surface, and another includes a flat surface in point-contact with the spherical surface.

15. The press apparatus of claim 12, wherein, among the at least one first pair of wear plates, one includes a circumferential surface, and another includes a V-shaped groove surface or a flat surface in line-contact with the circumferential surface.

16. The press apparatus of claim 12,
wherein each of at least one second pair of wear plates among the plurality of wear plates includes a flat surface to be in surface-contact with each other; and
wherein a spring is provided on at least one of the at least one second pair of wear plates in surface-contact with each other through the flat surface.
